(19) United States
(12) Patent Application Publication
(10) Pub. No.: US 2006/0161916 A1
(43) Pub. Date: Jul. 20, 2006

(54) Script-based software installation via broadcast transport media

(76) Inventors: Thomas May, Wolfenbuettel (DE); Ralf Flemme, Hannover (DE); Wolfgang Kopmann, Hildesheim (DE); Peter Engel, Hildesheim (DE)

Correspondence Address: KENYON & KENYON LLP, ONE BROADWAY, NEW YORK, NY, 10004, US

(21) Appl. No.: 11/325,138

(22) Filed: Jan. 3, 2006

(30) Foreign Application Priority Data
Jan. 4, 2005 (DE) 102005000653.1

(51) Int. Cl. G06F 9/44; G06F 9/445

(52) U.S. Cl. 717/174; 717/100

(57) ABSTRACT

A method for installing software in an electronic device, which software implements functions in the electronic device and in which method installation-related data are received by the electronic device via a unidirectional global emission, are evaluated and processed in accordance with the evaluation.

### FIELD OF THE INVENTION

The present invention relates to a method and a system for installing software in an electronic device, which software implements functions of the electronic device. The present invention further relates to a control script, a computer program and a corresponding computer program product.

### BACKGROUND INFORMATION

With increasing complexity, electronic devices contain an ever increasing software component for implementing desired functions. This is true for example also of so-called infotainment systems that are often built into motor vehicles for example. So-called infotainment (information and entertainment) systems are defined as systems that are able to ensure an entertaining communication of educational contents and information. Following a delivery of such devices to customers it is often desirable or necessary to modify or upgrade the software of such devices. This kind of modification is also meant to include maintenance as well as the implementation of so-called updates and upgrades.

Several procedures are presently known in this area from the related art. On the one hand, an exchange of devices or parts of devices, i.e. of so-called modules, is often performed in service shops. In this context, a module is defined as a component of the device as a whole which comprises the software to be modified. It is further known to perform a software installation after inserting a suitable CD-ROM. For this purpose, the CD-ROM contains the data required for implementing the respective installation. Here it is necessary, however, that the electronic device, in which a software is to be modified or upgraded, has a CD drive.

Newer technologies that are known or in part already standardized include, inter alia, a data transmission via so-called broadcast transport media. This includes, for example, a transmission of data via so-called “digital audio broadcasting” (DAB) according to a so-called MOT standard (multimedia object transfer). Further it is known to perform a software update according to the so-called OSGi standard (open service gateway initiative). In this instance, the software update may also be performed while the software of the electronic device is running. The mechanisms operating according to the OSGi standard, however, are designed for a bidirectional connection between a suitable software provider and a necessarily required so-called gateway on the side of the electronic terminal device. This also implies higher costs.

### SUMMARY OF THE INVENTION

Starting from the cited related art, a method is provided for installing software in an electronic device, which software implements functions of the electronic device, and a corresponding system is provided. Furthermore, a control script, a computer program and a computer program product are provided.

According to the method of the present invention for installing software in an electronic device, which software implements functions in the electronic device, installation-related data are received by the electronic device via a unidirectional global emission, are evaluated and processed in accordance with the evaluation.

In one possible specific embodiment of the method according to the present invention, at least one so-called control script is provided in the installation-related data for the device-internal control and checking of the processing of the remaining installation-related data.

For this purpose, data for implementing a consistency check and a completeness check for example are stored in the at least one or in several control scripts. Furthermore, it is conceivable to provide an execution filter for checking the applicability of the received installation-related data in the electronic device.

In another specific embodiment of the method according to the present invention it is possible to perform the unidirectional global emission via the digital audio broadcasting (DAB) already mentioned at the beginning and/or via so-called digital video broadcasting (DVB).

Further it is conceivable to reduce the amount of the installation-related data by compressing them at least in part using a suitable algorithm. The suitable algorithm, for example, may be a so-called WinZip file.

With the aid of the method according to the present invention it is possible to perform an installation of software while the electronic device is in operation. This entails a reduction of the so-called standstill time.

Furthermore, the method according to the present invention may employ cost-effective broadcast transport media which operate in a unidirectional manner.

Likewise associated with a reduction of cost is the possibility of monitoring and autonomously controlling the installation from the side of the electronic device.

To be able to perform a cost-effective installation while the electronic device is in operation it is possible according to the method of the present invention to transmit installation-related data to the electronic device using a broadcast method such as DAB or DVB for example. The device receives the installation-related data, evaluates the information contained therein and stores this information, if indicated, or at least buffers it.

Since the installation-related data are not suitable for every electronic device as a potential receiver of these data and since an installation of these data is to occur in a particular sequence it is advantageous to provide a control that can be implemented from the side of the electronic device. Such a control may be implemented by the already mentioned control script, which is likewise transmitted together with the installation-related data. This means that a control script of this kind may likewise be received via one of the mentioned broadcast transmissions.

In addition to pure program data, the installation-related data also contain a description of the content. This description of content includes for example a distributor of the installation-related data and a version number of the software thus transferred. The data further contain conditions of compatibility required for the installation and other features. So-called OSGi bundles, for example, contain such a structure.

The present invention further comprises a system for installing software in an electronic device, which software implements functions of the electronic device. For this purpose, the system according to the present invention has at least one receiver module situated in the electronic device for receiving installation-related data transmitted via a unidirectional global emission and one control unit situated in the electronic device for processing control instructions contained in the installation-related data.

In a possible specific embodiment of the system according to the present invention, the receiver is able to receive installation-related data transmitted via digital audio broadcasting (DAB) and/or via digital video broadcasting (DVB).

The present invention further relates to a control script for controlling an installation of software in an electronic device, which software implements functions of the electronic device. For this purpose, the control script comprises a checklist of requirements made on the electronic device that are necessary for the installation and of data necessary for the installation.

Furthermore, the control script may comprise an execution filter referencing device properties and installation-specific implementation instructions.

It is conceivable that a control unit provided on the electronic device, which may be referred to in exemplary fashion as a so-called “maintenance manager”, is controlled via a control script according to the present invention. For this purpose, as already mentioned, the control script is likewise received together with the installation-related data via a unidirectional global broadcast.

For this purpose, a control script according to the present invention may contain the version of the script, a title and as information a description of the actions triggered by the script. In addition there may be a provision for the control script to comprise a checklist, a so-called checksum for checking the consistency of the script. It is also possible for the control script to include a filter, which controls the execution of the script, i.e. a so-called execution filter. Such an execution filter references for example device properties such as e.g. a gateway ID, gateway properties or old software versions. In addition, a control script may provide instruction as to how the script is to be executed. These are so-called execution instructions. Such an execution instruction may include, for example, whether an execution of the installation is to proceed with or without an interaction with a user. Furthermore, a control script may comprise one or several commands for installing or uninstalling data. Such commands are, for example, “add” for “new installation”, “remove” for “delete”, “update” for “install new version” or “set” for “set variables”. Per command it is moreover possible to insert a filter for referencing the data packet, which may be called an action filter.

The installation-related data are managed for example by a control unit in the electronic device, namely, by an already mentioned maintenance manager (MM). Prior to executing an installation, this maintenance manager checks the consistency with the aid of the checksum stored in the mentioned control script and checks the applicability with the aid of the execution filter stored in the control script. A check is thereby performed as to whether the installation-related data fit with a system of the electronic device having the properties that it has and whether the installation can be executed. A completeness check further examines whether all necessary installation-related data are present. When transmitting data via broadcast channels it may often happen that individual data arrive belatedly due to interferences, particularly in the case of mobile reception. Only after the data have been successfully checked and all required data have been received is the installation cleared for execution. Following the clearance, first the execution instructions, which are likewise stored with the installation-related data, are processed. Here it may be stipulated, for example, whether an installation must be performed with user interaction or not. Subsequently, one action is processed after another in succession.

One great advantage of the present invention lies in the fact that large quantities of data may be transmitted in a cost-effective manner via a unidirectional global broadcast such as, for example, via a broadcast transmission. This allows for a cost-effective installation while the electronic device is in operation. Further, a coordination of the installation for each individual device is eliminated since the device is able to install the received data automatically using the control scripts.

The present invention further comprises a computer program having a program code for implementing all of the steps of a method according to the present invention if the computer program is executed on a computer or a corresponding computing device, particularly in a system according to the present invention.

The present invention also relates to a computer program product having a program code that is stored on a computer-readable data carrier for implementing a method according to the present invention if the computer program is executed on a computer or a corresponding computing device, in particular in a system according to the present invention.

### BRIEF DESCRIPTION OF THE DRAWING

FIG. 1 schematically depicts a specific embodiment of a system according to the present invention.

### DETAILED DESCRIPTION

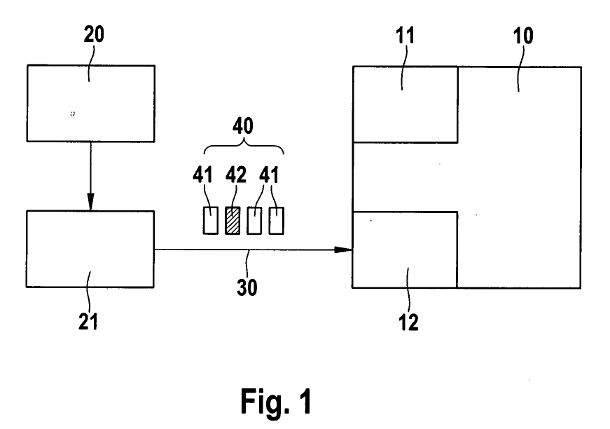

FIG. 1 shows an electronic terminal device 10. Electronic terminal device 10 has a local control unit 11 situated inside of it, which may also be referred to as a so-called “maintenance manager” (MM). Electronic device 10 further comprises a receiver 12, which is able to receive data via a unidirectional global broadcast. FIG. 1 further shows a software provider 20, who is able to emit data such as, for example, installation-related data via a transmitter unit 21. Such installation-related data may be broadcast via a broadcast transport channel 30 for example. If a particular software, which is required for implementing specific functions of the electronic device, is to be installed on electronic device 10, then receiver 12 is able to receive data sent by a software provider 20 via a transmitter 21. In the example depicted here the installation-related data 40 comprise three data packets 41 and one control script 42. All three data packets 41 and control script 42 are first received by receiver 12 and at least control script 42 is now transmitted to control unit 11. Control unit 11 is controlled via control script 42. This means that, on the basis of the information stored in control script 42, control unit 11 first checks the consistency with the aid of a checksum stored in control script 42. Control unit 11 further checks the applicability of the script or of the installation-related data with the aid of an execution filter stored in control script 42. A check is thereby performed as to whether the installation-related data fit with the system of electronic device 10 having the properties that it has and whether the installation can be executed if indicated. Control unit 11 further checks whether receiver 12 has received all required data packets from software provider 20 via transmitter 21. Only once the points specified by control script 42 have been successfully checked and all installation-related data have been received, will an installation, which corresponds to a processing of the data, be cleared for execution. Following the clearance, first the execution instructions are processed, which are also stored in the data.

For monitoring a result of an installation it is possible to send a feedback to software provider 20 via a suitable channel such as a mobile telephone connection for example.

Control script 42 may be written in a so-called XML format for example. An example of such a control script 42 looks as follows:

<?xml version=“1.0” encoding=“UTF-8”?>
<!-- @Author = Robert Bosch GmbH - FV/SLM-MMD - Engel --->
<update version=“3.3.4” title=“Install BundleManagementUI”
Description=“TestScript to demonstrate automatic update by script”
Checksum=“12345678”>

<gatewayproperties Gateway-ID=“0” Software-Version=“0”/>
<operations Execution=“forte”>

<action0 Command=“remove”>

<bundle Bundle-Name=“SoftwareDownloadTest” Bundle-

Version=“‘==’0.3”/>

</action0>
<actionI Command=“add”>

<bundle Bundle-Name=“A”
Bundle-Version=“‘==’0.2” UI-Design=

“ ==‘Classic DRIVE” UI-Toolkit=“‘==’Espresso”/>

</actionI>
<action2 Command=“set”>

<property Property-Type=“System”
Proper.ty-Key=“Software-State”

Property-Value=“I”/>

</actionI>

</operations>

</update>

What is claimed is:

1. A method for installing software in an electronic device, the software implementing functions in the electronic device, the method comprising:
receiving installation-related data by the electronic device via a unidirectional global emission;
evaluating the installation-related data; and
processing the installation-related data in accordance with the evaluation.

2. The method according to claim 1, wherein the installation-related data includes at least one control script for a device-internal control and checking of the processing of remaining installation-related data.

3. The method according to claim 2, wherein the at least one control script includes data for implementing a consistency check and a completeness check and an execution filter for checking an applicability of the received installation-related data in the electronic device.

4. The method according to claim 1, wherein the unidirectional global emission occurs via a unidirectional data connection, via at least one of digital audio broadcasting and digital video broadcasting.

5. The method according to claim 1, wherein the installation-related data is at least in part compressed.

6. A system for installing software in an electronic device, the software implementing functions in the electronic device, the system comprising:
at least one receiving module situated in the electronic device for receiving installation-related data broadcast via a unidirectional global emission; and
a control unit situated in the electronic device for processing control instructions contained in the installation-related data.

7. The system according to claim 6, wherein the receiver receives the installation-related data broadcast via a unidirectional data connection, via at least one of digital audio broadcasting and digital video broadcasting.

8. A control script for controlling an installation of software in an electronic device, the software implementing functions of the electronic device, the control script comprising:
a checklist of requirements made on the electronic device that are necessary for the installation and of data necessary for the installation.

9. The control script according to claim 8, further comprising:
an execution filter referencing device properties and installation-specific implementation instructions.

10. A computer-readable medium containing a program which, when executed by a processor, performs the following method for installing software in an electronic device, the software implementing functions in the electronic device:
receiving installation-related data by the electronic device via a unidirectional global emission;
evaluating the installation-related data; and
processing the installation-related data in accordance with the evaluation.
